(19) United States
(12) Patent Application Publication
(10) Pub. No.: US 2004/0100793 A1
(43) Pub. Date: May 27, 2004

(54) Outdoor strobe light

(75) Inventor: Perry H. Monitto, Setauket, NY (US)

Correspondence Address: Paul J. Farrell, Esq., DILWORTH & BARRESE, LLP, 333 Earle Ovington Blvd., Uniondale, NY, 11553, US

(73) Assignee: MULTI-MEDIA ELECTRONICS, INC., FARMINGDALE, NY

(21) Appl. No.: 10/302,114

(22) Filed: Nov. 22, 2002

(51) Int. Cl. F21S 8/00

(52) U.S. Cl. 362/153.1; 362/103; 362/3; 362/240; 362/153; 362/479; 362/17

(57) ABSTRACT

A waterproof outdoor strobe light having a housing body, a lamp assembly including a lamp tube, and a housing cover is provided. The housing cover may be colored and transparent or translucent to emit light in multiple directions through replaceable lenses. The lamp tube is installed on a front end of the housing and protrudes from the housing to emit light in every direction. The housing body has a sufficient interior space to dissipate heat generated by the lamp tube without the need for air vent slots. A gasket is positioned between the housing body and housing cover for waterproofing. The light may include a supporting assembly to fix the light on the ground.

### BACKGROUND OF THE INVENTION

1. Technical Field

The present invention relates to a strobe light for lighting a certain limited area, and more particularly, to a waterproof strobe light including a multidirectional light tube and multiple lenses.

2. Background of the Related Art

Outdoor strobe lights are widely used in domestic, industrial and commercial settings in safety, notification, intrusion systems and the like. Typically, such a strobe light comprises a housing including a flash tube generally surrounded by a reflector.

Various types of outdoor strobe lights have been developed.

For example, U.S. Pat. No. 4,084,215 to Willenbrock is directed to a strobe light for reducing electromagnetic radiation, having a housing, a flash tube placed in the housing, and a reflector mounted in the housing. The light from the flash tube passes through a light pipe to a reflector and the light pipe is surrounded by a waveguide, which is designed to operate below cut-off frequency thereby providing attenuation to the RF waves radiated from the flash tube.

U.S. Pat. No. 4,317,625 to Van Allen is directed to a strobe reflector assembly including a housing assembly having a pair of opposed wall sections defining an open-ended cavity and having a reference surface therein, and an artificial illumination tube having a preselected portion longitudinally positioned within the cavity and relative to the predetermined length of the reflecting surface to facilitate optimum light distribution.

U.S. Pat. No. 5,213,411 to Haus et al. is directed to a strobe light including a base, a lens having a generally cylindrical side wall defining an opening at one end and having an end wall at the other end, and a lamp assembly mounted on tapered, cruciform mounting posts on the base and is received within the side wall of the lens.

Even though these strobe lights may be suitable for the specific individual purposes for which they are designed, they differ from the present invention in that the present invention provides several unique features and advantages as hereinafter described.

### SUMMARY OF THE INVENTION

An object of the present invention is to provide a novel type of outdoor strobe light for illuminating a dark site, which has a simple configuration, is convenient to use, and is economical to manufacture.

In accordance with the present disclosure, an outdoor strobe light having a housing consisting of a housing body, a front base, a lamp assembly including a lamp tube, and a housing cover is provided. The housing may be of various shapes and the housing cover may be colored and transparent or translucent to emit soft and beautiful light in multi-directions through replaceable lenses in the housing cover. The lamp tube is mounted on the front base of the housing and protrudes from the front base to emit light in the every direction. The housing body may be various shapes and has an enough inner space for dissipating heat without air vent slots, making the strobe light waterproof by combining the housing cover and the housing body through a water proof gasket without the need for vent slots.

### BRIEF DESCRIPTION OF THE DRAWINGS

The above objects and other advantages of the present invention will become more apparent from the following detailed description taken in conjunction with the accompanying drawings, in which:

FIG. 1 illustrates a front perspective view of an outdoor strobe light in accordance with a preferred embodiment of the present invention;

FIG. 2 illustrates an exploded perspective view of the outdoor strobe light of FIG. 1;

FIG. 3 illustrates a perspective view showing an embodiment of the strobe light having a supporting assembly including a retaining stake and a holding bracket;

FIG. 4 illustrates a perspective view showing an embodiment of the strobe light having a handle;

FIG. 5 illustrates a side view in partial cut-away showing an alternative embodiment of the supporting assembly; and

FIG. 6 illustrates a perspective view of the embodiment of the strobe light having the supporting assembly of FIG. 5.

### DETAILED DESCRIPTION OF PREFERRED EMBODIMENTS

Preferred embodiments of the presently disclosed strobe light will now be described in detail with reference to the drawings in which like reference numerals designate identical or similar elements in each of the several views.

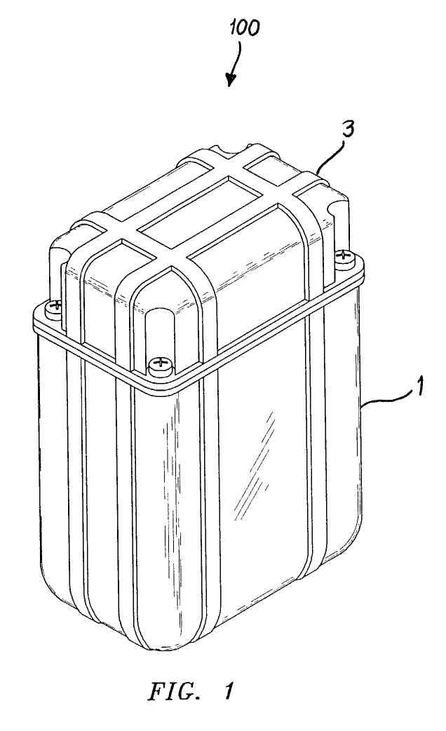

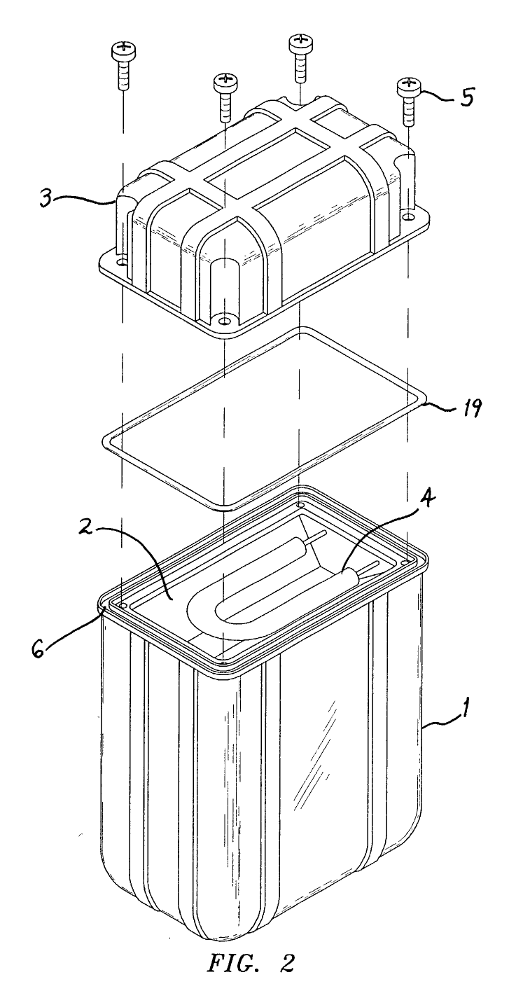

Referring to FIGS. 1 and 2, an outdoor strobe light comprises a housing body 1 and a housing cover 3, which may be of various shapes, such as cubic, cylindrical etc. The housing body 1 and the housing cover 3 combine together and form the housing. The housing body 1 is opened at a first end and closed at an opposite second end, and has an interior space defined by its walls of sufficient volume for dissipating any heat generated from the lamp assembly, without the need for air vent slots in the housing body 1. No vent slots are provided with the housing body 1 for water proofing the strobe light when the strobe light is used outdoors and is exposed to rain. The housing cover 3 may be colored and transparent or translucent, and has a dome like shape to emit light from the lamp assembly in multiple directions through the housing cover 3. The housing cover 3 may be detachable and replaced by other various types of housing covers 3 which have different colors or different shapes.

The lamp assembly consists of a reflector plate 2 and a lamp tube 4. The reflector plate 2 is preferably highly polished, faceted and configured to reflect the light from the lamp tube 4. The reflector plate 2 is located adjacent to the open end of the housing 1 and the lamp tube 4 is mounted over the reflector plate 2. The lamp tube 4 emits light through cover 3. Appropriate circuitry is provided in the interior space to generate a voltage to operate the strobe lamp 4. A power cord is provided (not shown) to power the light.

Referring to FIG. 2, the housing body 1 and the housing cover 3 are fit to each other to form a waterproof housing. One preferred embodiment of the combining means includes screws to secure the cover 3 to the body 1. It is also contemplated that the cover 3 be secured to the body 1 by a hinge, with a means for securing the cover such as a latch, or screws being provided opposite the hinge. As mentioned above, the housing cover 3 is detachable and replaceable by other housing covers. Preferably, a groove 6 is configured on the perimeter of enclosure face of housing body 1 or housing cover 3, or both sides, to accommodate a gasket 19, positioned in the grooves between the housing body 1 and the housing cover 3 to prevent water from infiltrating into the housing and onto the electrical components. The gasket 19 consists of rubber or silicone for tight fitting the gaps between the housing body 1 and the housing cover 3.

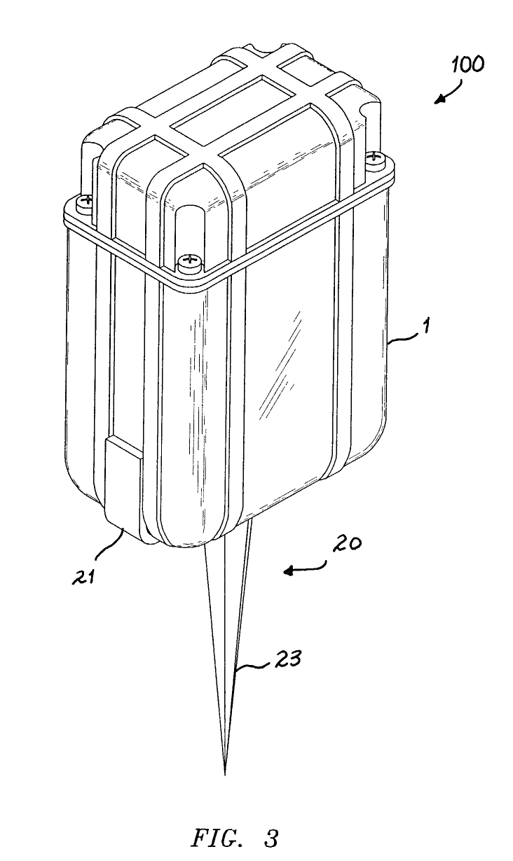

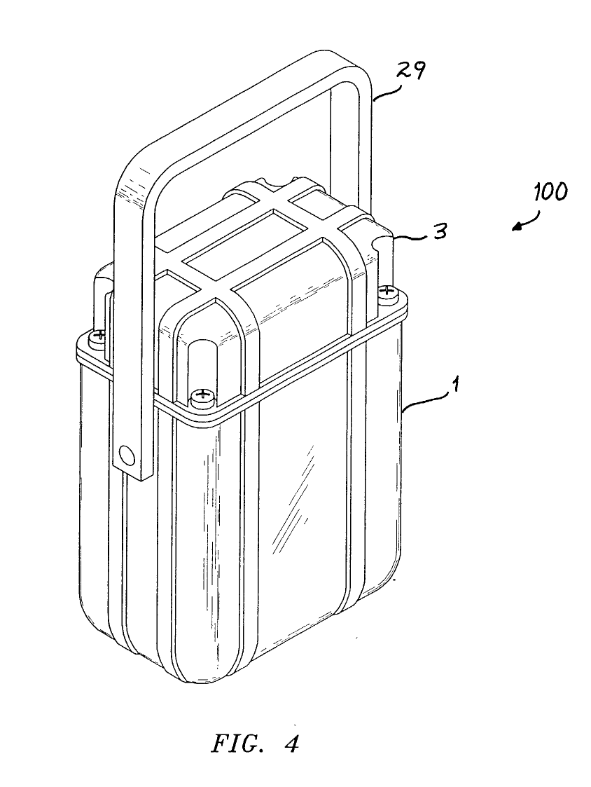

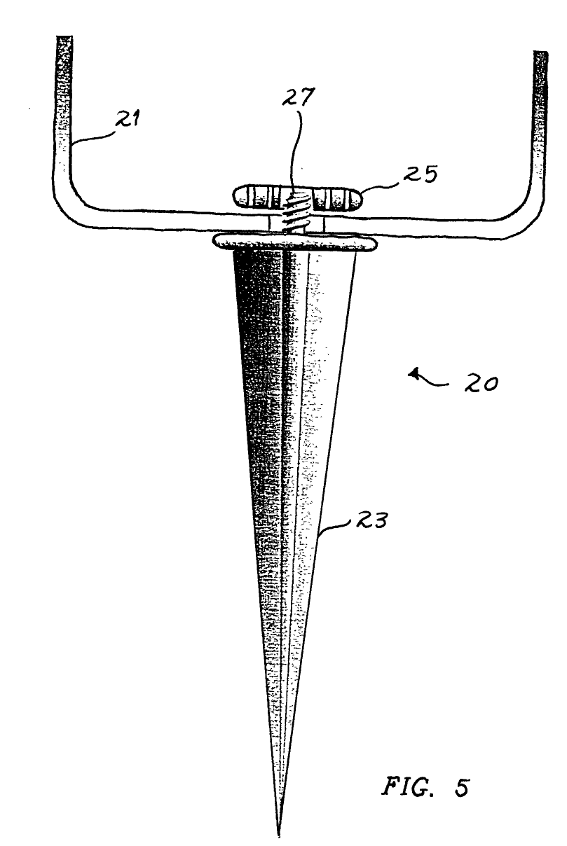

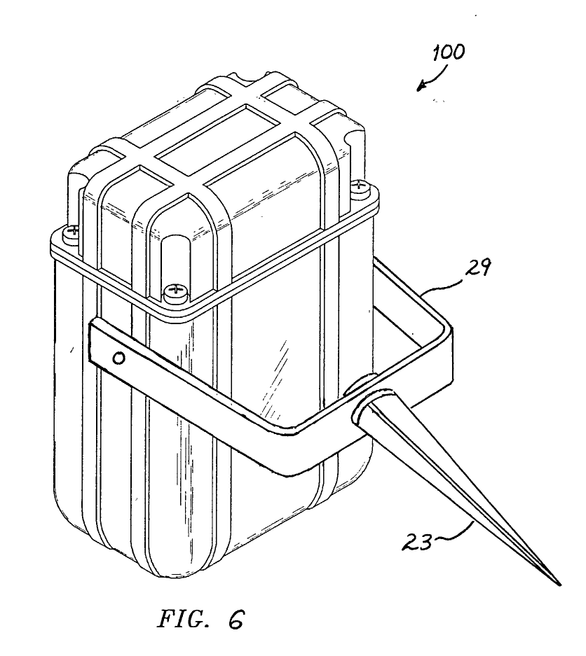

Referring to FIGS. 3, 5 and 6, an embodiment of a supporting assembly is provided to hold the strobe light and fix the strobe light on the ground. Supporting assembly 20 includes a retaining stake 23 and a holding bracket 21 positioned on the retaining stake 23. In FIG. 5, the retaining stake 23 includes a screw 27 on the one end thereof to be fastened by a retaining nut 25, to attach the stake to bracket 21, or a handle, similar to the handle 29 of FIGS. 4 and 6, which has a hole therein through which the protruded screw 27 is inserted so that the holding bracket 21 is firmly installed on the retaining stake 23 through the retaining nut 25. The other end of the retaining stake 23 has a sharp end to be easily fixed into the ground. In the embodiment of FIG. 3, bracket 21 may be secured to body 1 by means of a friction fit.

Referring to FIG. 4, a handle 29 may be provided to provide a means for carrying the strobe light, which is secured to the body in a conventional manner. The handle 29 may also be used to prop up the light 100 when the light is placed on a flat surface, or used to hang the light from a hook.

It will be understood that various modifications may be made to the embodiments disclosed herein. Therefore, the above description should not be construed as limiting, but merely as exemplifications within the scope and spirit of the claims appended hereto.

What is claimed is:

1. A strobe light comprising:
a body having sidewalls, a first open end, and a second closed end having an end wall;
a lamp assembly including a strobe lamp and a reflector plate, the reflector plate being positioned adjacent to the open first end of the body, and the strobe lamp being positioned on a side of the reflector plate facing the open first end;
circuitry for generating a voltage to operate the strobe lamp; and
a transparent cover for closing the open first end of the body, the cover having side walls, an open end and a closed end, the open end facing the open first end of the body and being secured thereto; and
wherein light emitted by the strobe lamp is emitted through the cover in more than one direction.

2. A strobe light according to claim 1, further comprising a gasket positioned between the housing body and the housing cover for waterproofing the strobe light.

3. The light according to claim 2, wherein grooves are defined on the perimeter of the open end of one of the body or the cover to accommodate the gasket.

4. The light according to claim 1, further comprising a handle mounted on the body.

5. The light according to claim 1, wherein the body and the cover are secured to each other by screws.

6. The light according to claim 1, wherein the body and the cover are secured to each other by a hinge and a latch.

7. The light according to claim 1, further comprising a retaining stake to secure the light into the ground.

8. The light of claim 1, wherein the body has an interior space within which heat generated by the lamp is dissipated.

9. The light according to claim 4, wherein the handle is provided with a retaining stake to secure the light into the ground.
